(19) United States
(12) Patent Application Publication
(10) Pub. No.: US 2012/0042184 A1
(43) Pub. Date: Feb. 16, 2012

(54) COMPUTER MOTHERBOARD CAPABLE OF REDUCING POWER CONSUMPTION IN SUSPEND

(75) Inventors: Chun Te Yeh, Taipeihsien (TW); Chung Wen Chen, Taipeihsien (TW)

(73) Assignee: MICRO-STAR INTERNATIONAL CORPORATION LIMITED, Taipeihsien (TW)

(21) Appl. No.: 13/013,096

(22) Filed: Jan. 25, 2011

(30) Foreign Application Priority Data
Aug. 13, 2010 (TW) 099215524

(51) Int. Cl. G06F 1/32

(52) U.S. Cl. 713/323

(57) ABSTRACT

A computer motherboard has a newly added DS3W mode, which is capable of reducing power consumption of the computer motherboard in Suspend. With a power-saving control device and a power switch device that are newly added to the computer motherboard, power supply to a main memory, the power-saving control device, and the power switch device is maintained continuously, while all the other elements of the computer motherboard may be powered off, but the computer motherboard still has the capability of waking up and resuming from a conventional sleep S3 state, so as to save more power. When a user presses a power button, the power-saving control device and the power switch device resume power supply to the elements that are previously powered off.

### CROSS-REFERENCE TO RELATED APPLICATIONS

This non-provisional application claims priority under 35 U.S.C. §119(a) on Patent Application No(s). 099215524 filed in Taiwan, R.O.C. on Aug. 13, 2010, the entire contents of which are hereby incorporated by reference.

### BACKGROUND OF THE INVENTION

1. Field of Invention

The present invention relates to a computer motherboard, and more particularly to a computer motherboard capable of saving more power in a Suspend to Memory state.

2. Related Art

Referring to FIG. 1, when a conventional computer motherboard 1 enters a Standby/Suspend state of an advanced configuration and power interface (ACPI) Suspend to Memory (S3), although the conventional computer motherboard 1 has entered a power-saving mode, part of chips of the conventional computer motherboard 1 still consume power continuously. For example, a main memory, a platform controller hub (PCH, or a southbridge chip), a super input output (SIO) chip, and a memory controller all consume power, and even a central processing unit (CPU) having the memory controller built therein consumes power, such that the power consumption cannot be further effectively reduced. To save power of the conventional computer motherboard 1, input power sources of power consuming components are shut down through individual control, or the power consuming components are even made to enter a sleep mode only through program control, so as to reduce power consumption. However, the PCH (southbridge chip) is used to control the ACPI, the SIO chip is used to control on and off state of the computer, and both the PCH and the SIO chip cannot be shut down in a Standby/Suspend state. The design methods are different for computer motherboards using different chipsets, and different components on the computer motherboard should be considered, and different control methods need to be designed, which is complicated and has increased cost, and cannot be used in other designs. As a result, the labor consumption is high and development time is long during the design process, and thus the production cost is increased.

Presently, in the recent desk-top computer platforms and notebook computer platforms of Intel™ Corporation, two modes, that is, an active sleep power well (ASW) mode and a deep sleep power well (DSW) mode, are newly added in power management modes. In the ASW mode, if the computer system enters S3, and a network chip of Intel™ Corporation is used, the computer system may also provide multiple remote monitoring and management functions for network managers, but at this time, elements related to a management engine (ME), such as the memory, the network chip, and the SIO chip, consume power continuously. However, in the ASW mode, if functions of a local area network (LAN) or the ME of INTEL are not used, when the computer system enters the S3 mode, a power source of the ME of the PCH (or southbridge chip) may be shut down. However, the PCH (or southbridge chip), the main memory, the network chip, and the SIO chip still consume power continuously. In the DSW mode, when the computer system enters DeepS4 or DeepS5, the computer system may shut down all unnecessary power, with power remaining only in parts related to a wake up mechanism inside the PCH (or southbridge chip), which means that, the computer system has only a real time clock (RTC) chip and a power button left to wake up the computer system, and other wake up methods are ignored. Thus, although the effect of reducing power consumption and saving energy is further achieved, rapid recovery and power saving is absent.

The following table is used to illustrate the power consumption of electronic components on the conventional computer motherboard under the ACPI specification of Intel™ for the conventional computer motherboard.

| Elements still | | | | | | |
|---|---|---|---|---|---|---|
| supplied with | Elements to be | | | | | |
| power in each state | supplied with power | G3 | DeepSx | Sx/Moff | M3 | S0/M0 |
| Elements still | All elements for | off | Off | Off | off | On |
| supplied with | normally executing | | | | | |
| power in an ON | S0 state | | | | | |
| state | | | | | | |
| Elements still | All elements of ME | off | Off | Off | On | On |
| supplied with | subsystem, | | | | | |
| power in ASW | including: SRAM, | | | | | |
| | LAN MAC, and I/O | | | | | |
| Elements still | Conventional wake | Off | Off | On | On | On |
| supplied with | logic and context for | | | | | |
| power in Suspend | resume from Sx state | | | | | |
| Elements still | Primitive wake | Off | On | On | On | On |
| supplied with | source, such as | | | | | |
| power in DSW | power button and | | | | | |
| | RTC alarm | | | | | |
| Elements still | RTC Clock, CMOS, | On | on | on | on | on |
| supplied with | basic context to be | | | | | |
| power in an OFF | used after G3 state | | | | | |
| state | | | | | | |

U.S. Pat. No. 6,266,776, entitled “ACPI Sleep Control”, has disclosed that when the state of an internal battery or an external power supply state changes, the change may be detected by an embedded controller; the operation system is informed of this change using a power management event signal POWER_PME and an SCI interrupt; accordingly, the current system state of the operation system changes to another system state. U.S. Pat. No. 6,266,776 does not disclose that at least the southbridge chip and the SIO chip of the computer motherboard are further powered off in an S3 state of the ACPI, so as to save power.

In view of the disadvantages of the conventional computer motherboard, the inventor creates an improved computer motherboard to eliminate the disadvantages.

### SUMMARY OF THE INVENTION

Accordingly, the present invention is a computer motherboard, for reducing power consumption in a Suspend to Memory state.

The present invention is further a computer motherboard. In a Suspend state, power supply to only a main memory, part of elements related to a DSW mode inside a PCH, and a power-saving control device and a power switch device of the present invention is maintained continuously, while all the other elements can be powered off, and the computer motherboard still has the capability of waking up and resuming from an S3 state, so as to save more power.

In order to achieve the above objectives, the present invention provides a computer motherboard capable of reducing power consumption in a Suspend state. The computer motherboard is electrically connected to a power supply and at least comprises: a CPU socket for disposing a CPU therein, a memory controller, a PCH, an SIO chip, a communication chip, a plurality of main memory sockets for connecting a main memory formed by dynamic random access memories having an automatic self-refreshing function, a main memory power supply module, and a basic input output system (BIOS). The main memory power supply module is capable of supplying power to the main memory continuously in an ASW mode, supplying power to part of elements related to a DSW mode inside the PCH continuously in the DSW mode, and powering off the main memory in the DSW mode. The computer motherboard further comprises: a power-saving control device, electrically connected to the PCH, for commanding a power switch device to form an open circuit when determining that the computer motherboard is in a state between the ASW mode and the DSW mode, receiving a power switching signal generated by a power button, and commanding the power switch device to form a closed circuit after receiving the power switching signal; and the power switch device, controlled by the power-saving control device, in which an input end of the power switch device is electrically connected to the power supply, and an output end of the power switch device is at least electrically connected to power input pins of the CPU, the memory controller, the PCH, the SIO chip, and the communication chip. Thereby, when the power switch device forms an open circuit, the power input pins are electrically connected to the output end of the power switch device, and thus form an open circuit with the power supply; and when the power switch device forms a closed circuit, the power input pins are electrically connected to the output end of the power switch device, and thus form a closed circuit with the power supply.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of a conventional computer motherboard capable of reducing power consumption in a Standby/Suspend state;

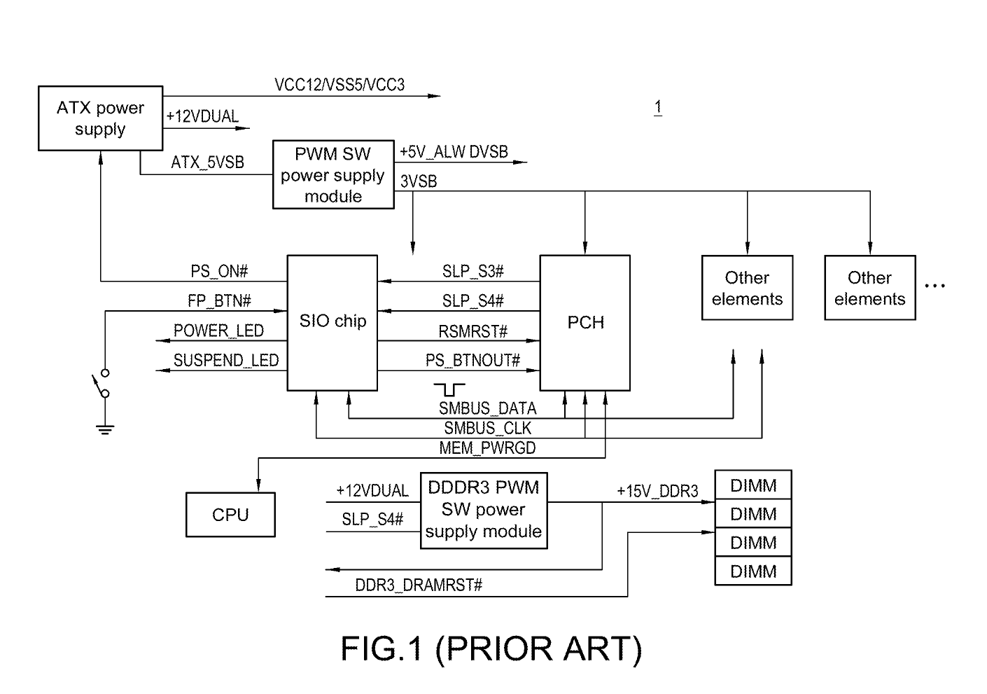

FIG. 2 is a schematic view of relations between a newly added DS3W power-saving mode of the computer motherboard and original power-saving modes in the present invention;

FIG. 3 is a schematic architectural view of a computer motherboard capable of reducing power consumption in the present invention;

FIG. 4 shows a specific embodiment of the present invention according to FIG. 3;

FIG. 5 is a flow chart of processing a DS3W event by a computer motherboard of the present invention;

FIG. 6 is a flow chart of processing wake up and resume from a DS3W state by the computer motherboard of the present invention;

FIG. 7 is a flow chart of entering DS3W state by the computer motherboard of the present invention; and

FIG. 8 is a flow chart of resuming from DS3W state by the computer motherboard of the present invention.

### DETAILED DESCRIPTION OF THE INVENTION

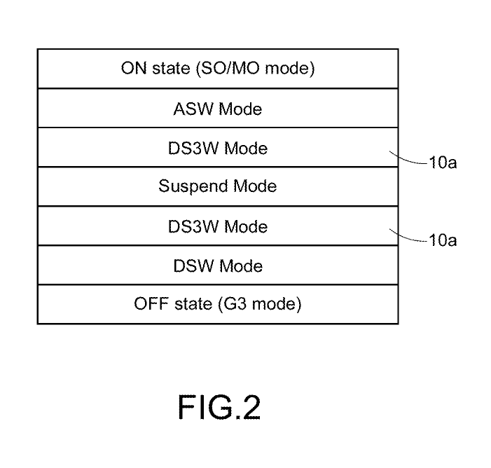

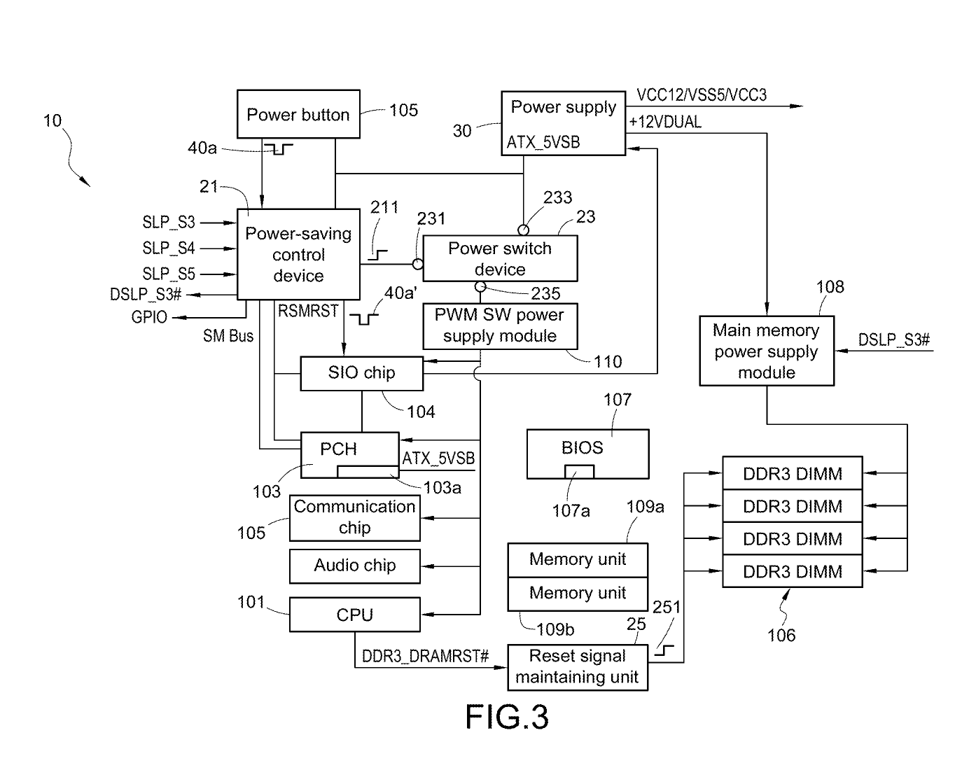

It can be seen from the table of power consumption of electronic components on a conventional computer motherboard under the ACPI specification of Intel™ for the conventional computer motherboard in the prior art that, although Intel™ provides ASW and DSW power-saving modes, the disadvantages described in the prior art still exist. Therefore, the present invention provides a novel power-saving mode capable of recovering the computer system more rapidly in a manner of saving more power between the ASW and DSW power-saving modes of Intel™. Referring to FIGS. 2 and 3, a computer motherboard 10 of the present invention has a DS3W power-saving mode 10a newly added. When the computer motherboard 10 enters the DS3W power-saving mode of the present invention, only a main memory, a power-saving control device 21, a power switch device 23, and part of elements related to a DSW mode inside a PCH 103 (hereinafter referred to as PCH internal elements 103a) consume power continuously, the other power consumption-related elements are all powered off; at this time, only an RTC and a power button can wake up the computer system. The computer motherboard 10 having the DS3W power-saving mode 10a of the present invention provides a power-saving function for the user to choose without affecting the functions of the computer system, that is, a new choice of power-saving function between the ASW and DSW power-saving modes, is added, thereby further achieving the purpose of energy saving and carbon reduction.

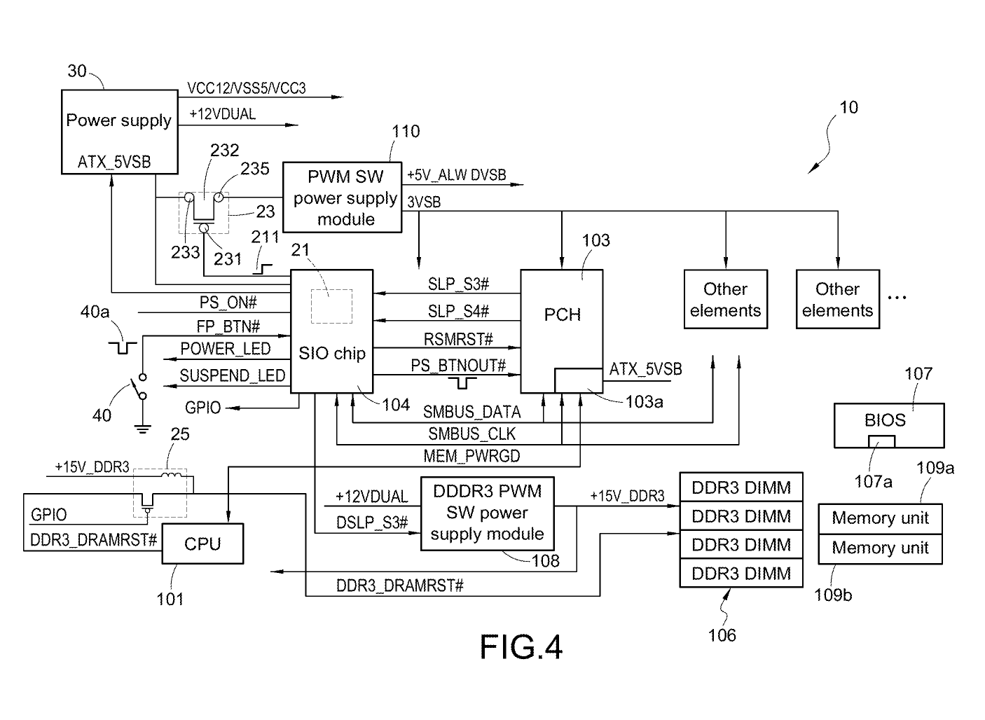

Referring to FIGS. 3 and 4, for ease of describing and understanding the present invention, only hardware components of the computer motherboard 10 directly related to the present invention are drawn, and the other components not directly correlated to the present invention of the computer motherboard 10 are omitted. Due to the design of the power-saving control device 21 and the power switch device 23, the computer motherboard 10 of the present invention is capable of saving more power than that of the ASW mode. At the same time, the present invention overcomes the disadvantage that the conventional computer host cannot cut off the power supply to the PCH 103 (or southbridge chip) and an SIO chip 104 in the ASW state. On the other hand, the computer motherboard 10 of the present invention also overcomes the disadvantage that the conventional computer host cannot wake up the computer system in the DSW state.

The power-saving control device 21 mainly includes three control signal lines, each for outputting the signal of DSLP_S3#, GPIO, and a control signal 211. The signal of DSLP_S3# is used for maintaining a power supply of the main memory 106 in a DS3W state. The signal of GPIO is used for resetting the main memory 106, and the control signal 211 is used for determining on and off state of a power switch device 23.

The computer motherboard 10 of the present invention mainly has added the design of the power-saving control device 21 and the power switch device 23, and the power of the power-saving control device 21 and the power switch device 23 is supplied from a power supply 30, which will be described below respectively. The computer motherboard 10 of the present invention further at least comprises: a CPU socket for disposing a CPU 101 therein, a memory controller 102, a PCH 103, an SIO chip 104, a communication chip 105, a plurality of main memory sockets for connecting a main memory 106 formed by dynamic random access memories having an automatic self-refreshing function, a main memory power supply module 108, and a BIOS 107. The PCH 103 may also be replaced by a southbridge chip. In order to make the present invention comprehensible, the CPU 101, the memory controller 102, and the PCH 103 (or southbridge chip) used in preferred embodiments of the computer motherboard 10 of the present invention are all products of Intel™ Corporation. The communication chip 105 may directly be a conventional relevant chip, such as a conventional wired network chip or a conventional wireless network chip. The SIO chip 104 may also directly be a conventional relevant chip. The main memory 106 adopts, for example, more than one dual in-line memory module (DIMM) formed by a DDR3 memory.

The power switch device 23 is controlled by the power-saving control device 21. A control end 231 of the power switch device 23 is connected to the power-saving control device 21 to receive a control signal 211 of the power-saving control device 21. An input end 233 of the power switch device 23 is electrically connected to the power supply 30, and an output end 235 of the power switch device 23 is at least electrically connected to power input pins of the CPU 101, the memory controller 102, the PCH 103, the SIO chip 104, and the communication chip 105.

One function of the power-saving control device 21 is to receive a power switching signal 40a generated by a power button 40. Another function of the power-saving control device 21 is to output a control signal 211 of a first voltage level when determining that the computer motherboard 10 is in the DS3W state, so as to command the power switch device 23 to form an open circuit. Still another function of the power-saving control device 21 is to output the control signal 211 of a second voltage level when receiving the power switching signal 40a, so as to command the power switch device 23 to form a closed circuit. The first voltage level and the second voltage level are different voltage values.

The power-saving control device 21 is electrically connected to the PCH 103 (or southbridge chip). The power-saving control device 21 determines whether the computer system enters an S3 mode by using an SLP_S3# signal and an SLP_S4# signal sent by the PCH 103 (or southbridge chip). When the SLP_S3# signal is at a low level, and the SLP_S4# signal is at a high level, the power-saving control device 21 determines that the computer system enters the S3 mode. In one embodiment, by employing the BIOS setup, the power-saving control device 21 may also enable its DS3W register.

When the power switch device 23 is in an open circuit state, the power input pins are electrically connected to the output end 233 of the power switch device 23, so as to form an open circuit with the power supply 30, that is, all the CPU 101, the memory controller 102, the PCH 103, the SIO chip 104, and the communication chip 105 are powered off. When the power switch device 23 is in a closed circuit state, the power input pins are electrically connected to the output end 233 of the power switch device 23, so as to form a closed circuit with the power supply 30, that is, power supply to all the CPU 101, the memory controller 102, the PCH 103, the SIO chip 104, and the communication chip 105 is resumed.

Referring to FIG. 4, the power-saving control device 21 is integrated into the SIO chip 104. The power switch device 23 is connected in series between the power supply 30 and a pulse width modulation switching (PWM SW) power supply module 110. The voltage converted by the PWM SW power supply module 110 is at least supplied to the CPU 101, the memory controller 102, the PCH 103, the SIO chip 104, and the communication chip 105. When a field effect transistor (MOSFET) 232 is in an OFF state, the PWM SW power supply module 110 forms an open circuit with the power switch device 23. When the field effect transistor (MOSFET) 232 is in an ON state, the PWM SW power supply module 110 forms a closed circuit with the power switch device 23. The power-saving control device 21 outputs control signals 211 of different voltage levels to a gate of the MOSFET 232, such that the MOSFET 232 can switch between an OFF state and an ON state.

The CPU 101 in FIG. 4 has the memory controller 102 built therein. When the computer motherboard 10 is in the DS3W state, power supply to only the DDR3 DIMMs 106, the PCH internal elements 103a, the power-saving control device 21, and the power switch device 23 is maintained, and all the other elements are powered off, and thus achieving a power-saving mode. Moreover, when the power source of the CPU 101 is shut down, the power source of the built-in memory controller 102 is also shut down, and thus a reset signal for the memory turns to a low voltage level, which results in data loss of the DDR3 DIMMs 106. In order to prevent the situation, a reset signal maintaining unit 25 is added in the present invention to output a reset signal 251 to the DDR3 DIMMs 106 when the computer motherboard 10 is in the DS3W state. The reset signal maintaining unit 25 is capable of keeping the reset signal unchanged which is still maintained at a high voltage level even after the memory controller 102 is powered off.

Herein, the power-saving control device 21 is described in detail. The power-saving control device 21 may adopt a micro controller for specific implementation. When the power-saving control device 21 is integrated with the SIO chip 104 into one chip, the power-saving control device 21 can directly adopt the micro controller inside the SIO chip 104.

After the power-saving control device 21 receives the power switching signal 40a, if the power-saving control device 21 adopts the design of another chip (that is, does not adopt the design of being integrated with the SIO chip 104), the power-saving control device 21 replicates the power switching signal 40a and outputs the replicated power switching signal 40a′ to the SIO chip 104 of the computer motherboard 10. Furthermore, after receiving the power switching signal 40a, the power-saving control device 21 commands the power switch device 23 to form a closed circuit.

The power-saving control device 21 may also be implemented by an application specific integrated circuit (ASIC).

The computer motherboard 10 resuming power supply generates an RSMRST signal (for example, generated by a second device 103 or the SIO chip 104), and transmits the RSMRST signal to the PCH 103 (or southbridge chip). Next, the computer motherboard 10 automatically executes a wake up procedure.

The function of the main memory power supply module 108 is to convert the power of the power supply 30 into power supplied to the DDR3 (or DDR2) DIMMs 106. Therefore, when the computer motherboard 10 is in the DS3W state, the power supply 30 still supplies power to the main memory power supply module 108. A specific embodiment of the main memory power supply module 108 is, for example, a DDR3 (or DDR2) PWM SW power supply module.

The conventional computer motherboard having the ASW mode and the DSW mode is still capable of continuously supplying power to the main memory in the ASW mode. On the other hand, the conventional computer motherboard in the DSW mode is still capable of continuously supplying power to part of elements related to the DSW mode inside the PCH while powering off the main memory. The computer motherboard 10 of the present invention can directly use a relevant conventional circuit as the reference of the power supply mode of the PCH internal elements 103a and the DDR3 (or DDR2) DIMMs 106.

In a multi-layered printed circuit board (PCB) of the conventional computer motherboard, a power source of the memory controller and the main memory are arranged together, and cannot be separated, mainly because the control signals must refer to a power source of the main memory. For example, in the conventional computer motherboard with a four-layered PCB, the power source of the memory controller is arranged together with the main memory on the fourth layer. In order that the power source of the memory controller 102 can be shut down in the DS3W mode, in the computer motherboard 10 of the present invention, the power source of the memory controller and the power source of the memory are arranged separately from each other, such that the power source of the memory controller 102 can be shut down in the DS3W mode without causing any influence on the power source of the main memory 106.

The power supply 30 may be specifically, for example, an ATX power supply, a power transformer, or replaced by a rechargeable battery.

The computer motherboard 10 of the present invention may be a computer motherboard for a desk-top computer, a computer motherboard for a notebook computer, or a computer motherboard for a flat panel computer.

Furthermore, for the purpose that the power-saving control device 21 and the power switch device 23 cut off the power supply to the PCH 103 (or southbridge chip) and the SIO chip, the BIOS 107 of the computer motherboard 10 of the present invention has a program code 107a added. The program code 107a is used for storing a first flag in a memory unit 109a when a DS3W event happens to the computer motherboard 10; and for checking the first flag to determine whether a previous state of the computer motherboard 10 has entered the DS3W state when power supply to the PCH 103 (or southbridge chip) and the SIO chip 104 is resumed, and if yes, a wake up procedure is executed. A memory unit 109b is used for storing a second flag, and the function of the second flag is to allow the program code 107a to determine whether the DS3W mode is enabled. The second flag may be set as Enable or Disable by using a BIOS setup menu. The memory unit 109a,109b can be implemented by two individual registers or two different bits within one register.

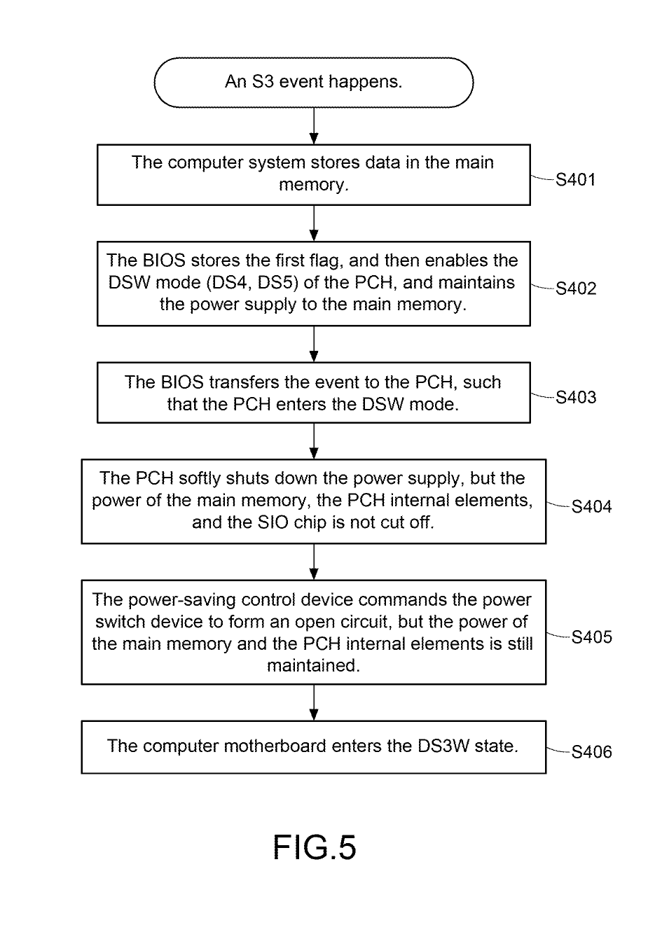

Referring to FIG. 5, in the case that the DS3W mode is set as Enabled, when a Suspend to Memory event (for example, an S3 event of ACPI) happens to the computer motherboard 10, the computer system (for example, Windows™ of Microsoft™ Corporation) stores the data in the main memory 106 (5401). Next, the program code 107a of the BIOS 107 stores the first flag in the memory unit 109a, and then enables the DSW mode (DS4, DS5) of the PCH 103, and maintains the power supply to the main memory (S402). Then, the program code 107a of the BIOS 107 transfers the event to the PCH 103, such that the PCH 103 enters the DSW mode (S403). Afterwards, the PCH 103 softly shuts down the power supply 30, but the power of the main memory 106, the PCH internal elements 103a, and the SIO chip 104 is not cut off (S404). Then, the power-saving control device 21 commands the power switch device 23 to form an open circuit, but the power of the main memory 106 and the PCH internal elements 103a is still maintained (S405). Next, the computer motherboard 10 enters the DS3W state (S406).

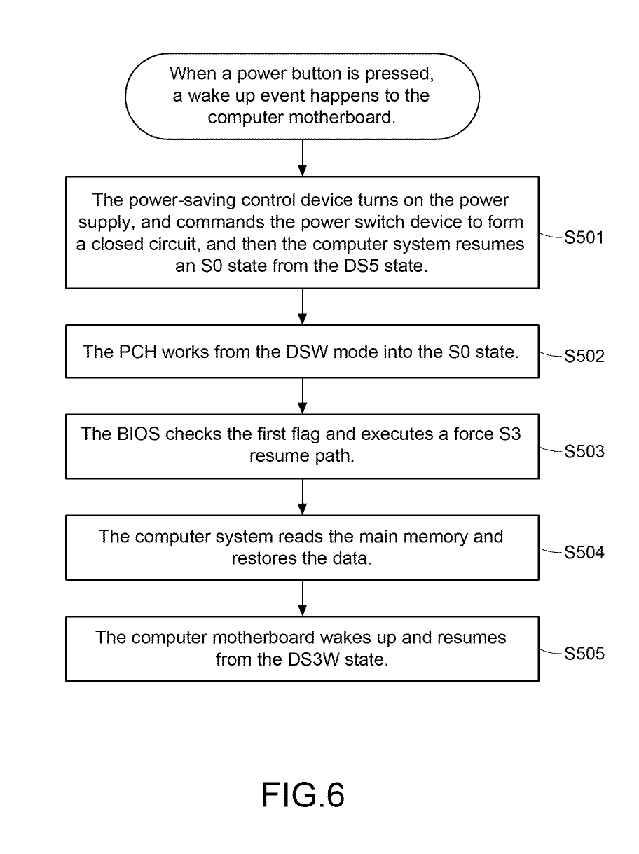

Referring to FIG. 6, when the user presses the power button 40, a wake up event happens to the computer motherboard 10. At this time, the power-saving control device 21 turns on the power supply 30, and commands the power switch device 23 to form a closed circuit, and then the computer system resumes an S0 state from the DS5 state (S501). Then, the PCH 103 works from the DSW mode into the S0 state (S502). Afterwards, the program code 107a of the BIOS 107 checks the first flag and executes a force S3 resume path (S503). Moreover, in 5503, the program code 107a can further clear the first flag value. Next, the computer system reads the main memory 106 and restores the data (S504). Then, the computer motherboard 10 wakes up and resumes from the DS3W state (S505).

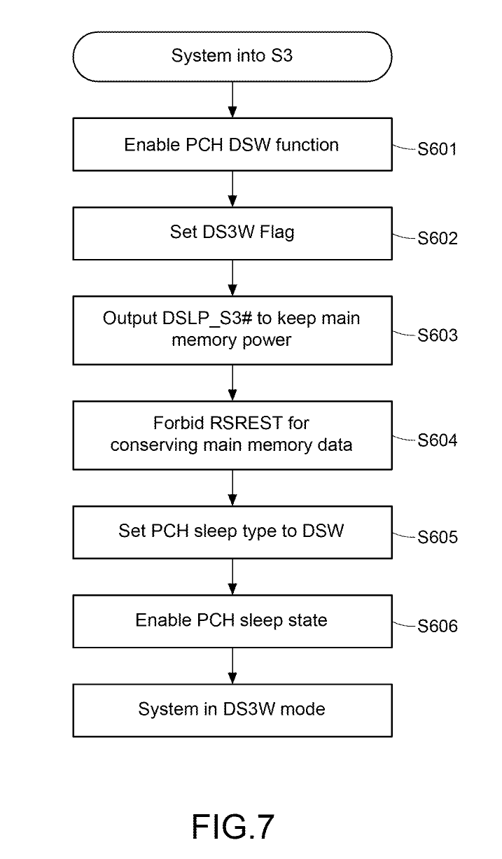

Referring to FIG. 7, the computer motherboard 10 is preset enable. Therefore, after the computer motherboard 10 enters S3 state, it performs steps of enabling the PCH 103 DSW function (S601), setting the DS3W flag (S602), outputting the signal of DSLP_S3# to keep power of the main memory 106 (S603), forbidding a signal of RSREST to conserve data of the main memory 106 (S604), setting sleep type of the PCH 103 to DSW (S605) and enabling the PCH 103 into sleep state (S606).

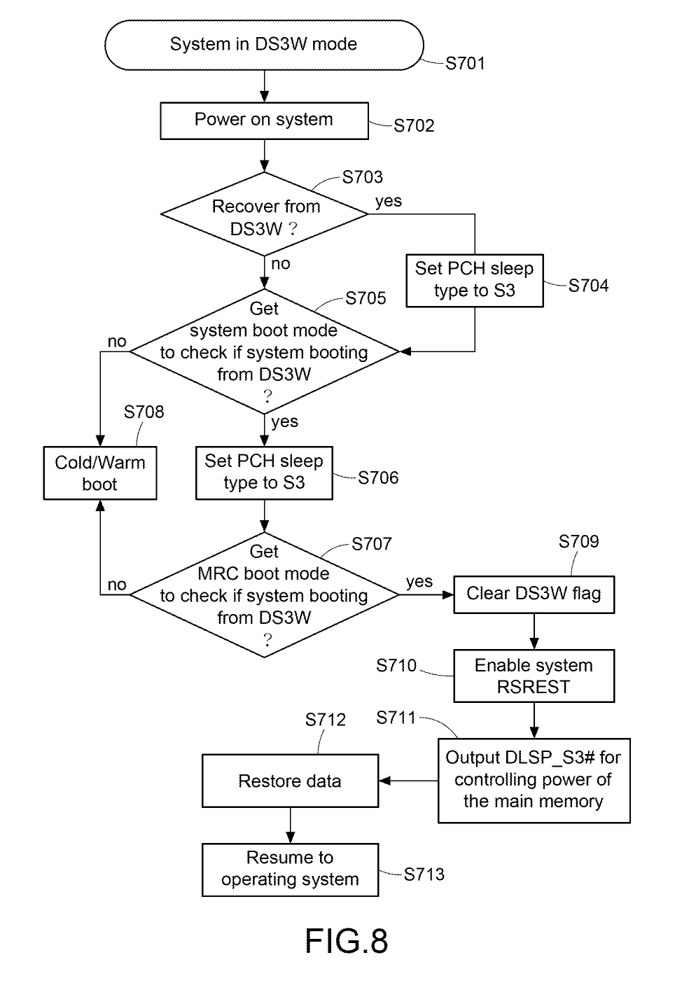

Further referring to FIG. 8, the system is in DS3W mode (S701) and the power button 40 is being pressed (S702). Therefore, the computer motherboard 10 recovers from the DS3W mode. First, it is determined if the computer motherboard 10 has recovered from the DS3W mode (S703). If yes, then the sleep type of the PCH 103 is set to be S3 (S704). Otherwise, it is determined if the system is boot from DS3W based on the system boot mode (S705). When the system is boot from DS3W, the sleep type of the PCH 103 is set to be S3 (S706). Later, the system is determined if it is boot from DS3W based on boot mode of the memory control code (MRC) in Intel BIOS (S707). If it is not, then a cold boot or a warm boot is performed (S708). Otherwise, the DS3W flag is cleared (S709) and the signal of RSREST is enabled (S710). Therefore, the signal of DSLP_S3# is output for controlling power of the main memory 106 (S711), data of the main memory 106 is restored (S712), and operating system is resumed (S713).

The memory units 109a and 109b may adopt the CMOS/DSW memories built in the computer motherboard 10 or the internal registers of the power-saving control device 21.

The computer motherboard of the present invention has the newly added DS3W mode, and with the design of the power-saving control device and the power switch device, in the DS3W state, power supply to only the main memory, the power-saving control device, the power switch device, and part of elements related to the DSW mode is maintained continuously, while all the other elements can be powered off, but the computer motherboard of the present invention still has the capability of waking up and resuming, which is the advantage and greatest feature of the present invention.

What is claimed is:

1. A computer motherboard capable of reducing power consumption in a Suspend state, electrically connected to a power supply and at least comprising: a central processing unit (CPU) socket for disposing a CPU therein, a memory controller, a platform controller hub (PCH), a super input output (SIO) chip, a communication chip, a plurality of main memory sockets for connecting a main memory formed by dynamic random access memories having an automatic self-refreshing function, a main memory power supply module, and a basic input output system (BIOS), wherein the main memory power supply module is capable of supplying power to the main memory continuously in an active sleep power well (ASW) mode, and supplying power to part of elements related to a deep sleep power well (DSW) mode inside the PCH continuously in the DSW mode, and powering off the main memory in the DSW mode, the computer motherboard comprising:
a power-saving control device, electrically connected to the PCH, for commanding a power switch device to form an open circuit and commanding the main memory power supply module to resume power supply to the main memory when determining that the computer motherboard is in a state between the ASW mode and the DSW mode, and for receiving a power switching signal generated by a power button, and commanding the power switch device to form a closed circuit after receiving the power switching signal; and
the power switch device, controlled by the power-saving control device, wherein an input end of the power switch device is electrically connected to the power supply, and an output end of the power switch device is at least electrically connected to power input pins of the CPU, the memory controller, the PCH, the SIO chip, and the communication chip;
when the power switch device forms the open circuit, the power input pins are electrically connected to the output end of the power switch device, and thus form the open circuit with the power supply; and when the power switch device forms the closed circuit, the power input pins are electrically connected to the output end of the power switch device, and thus form the closed circuit with the power supply.

2. The computer motherboard according to claim 1, wherein when the computer motherboard is in the state between the ASW mode and the DSW mode, the power-saving control device outputs a control signal such that the main memory power supply module supplies power to the main memory continuously.

3. The computer motherboard according to claim 1, wherein the power supply is an ATX power supply, a power transformer, or is replaceable by a rechargeable battery.

4. The computer motherboard according to claim 1, wherein the PCH is a southbridge chip.

5. The computer motherboard according to claim 4, wherein the southbridge chip is a product of Intel™ Corporation.

6. The computer motherboard according to claim 1, wherein the computer motherboard is a computer motherboard for a desk-top computer, a computer motherboard for a notebook computer, or a computer motherboard for a flat panel computer.

7. The computer motherboard according to claim 1, wherein the main memory at least comprises more than one DDR2 memory or DDR3 memory.

8. The computer motherboard according to claim 1, wherein the power-saving control device and the power switch device are powered by the power supply.

9. The computer motherboard according to claim 8, wherein the power-saving control device is integrated into the SIO chip, or is a micro controller or an application specific integrated circuit (ASIC).

10. The computer motherboard according to claim 1, wherein the power-saving control device is further used to replicate the power switching signal and output the replicated power switching signal to the SIO chip.

11. The computer motherboard according to claim 10, wherein the power-saving control device replicates the power switching signal and outputs the replicated power switching signal to the SIO chip by executing a program code to control a voltage level of an output port of the power-saving control device.

12. The computer motherboard according to claim 1, further comprising: a reset signal maintaining unit, for outputting a reset signal to the main memory when the computer motherboard is in the state between the ASW mode and the DSW mode.

13. The computer motherboard according to claim 1, wherein the CPU, the memory controller, and the PCH of the computer motherboard are products of Intel™ Corporation.

14. The computer motherboard according to claim 1, wherein the communication chip is a wired network chip or a wireless network chip.

15. The computer motherboard according to claim 1, wherein the power switch device is connected in series between the power supply and a pulse width modulation switching (PWM SW) power supply module, and the PWM SW power supply module is used to convert a power of the power supply into a power supplied to the CPU, the memory controller, the PCH, the SIO chip, and the communication chip.

16. The computer motherboard according to 1, wherein the main memory power supply module is used to convert a power of the power supply into a power supplied to the main memories.

17. The computer motherboard according to claim 1, further comprising: at least one memory units, for respectively storing a flag value.

18. The computer motherboard according to claim 1, wherein a power source of the memory controller and a power source of the memory are arranged separately from each other.

19. A computer motherboard comprising:
a power-saving control device, electrically connected to a platform controller hub (PCH), for commanding a power switch device to form an open circuit when determining that the computer motherboard is in a state between an active sleep power well (ASW) mode and a deep sleep power well (DSW), and for receiving a power switching signal generated by a power button, and commanding the power switch device to form a closed circuit after receiving the power switching signal;
the power switch device, controlled by the power-saving control device, wherein an input end of the power switch device is electrically connected to a power supply, and an output end of the power switch device is at least electrically connected to power input pins of a central processing unit (CPU), a memory controller, the PCH, a super input output (SIO) chip, and a communication chip, wherein when the power switch device forms the open circuit, the power input pins are electrically connected to the output end of the power switch device, and thus form the open circuit with the power supply; and when the power switch device forms the closed circuit, the power input pins are electrically connected to the output end of the power switch device, and thus form the closed circuit with the power supply;
a plurality of main memory sockets, for connecting a main memory formed by dynamic random access memories having an automatic self-refreshing function;
a main memory power supply module, for resuming power supply to the main memory when the computer motherboard is in a state between the ASW mode and the DSW mode; and
a flash memory, for storing at least one program code of a basic input output system (BIOS), wherein the program code of the BIOS is used for the CPU executing a DS3W event.

20. The computer motherboard according to claim 19, further comprising: at least one memory unit, each for storing a flag associated with the DS3W event.
